(19) United States
(12) Patent Application Publication
(10) Pub. No.: US 2024/0158629 A1
(43) Pub. Date: May 16, 2024

(54) POLYESTER RESIN COMPOSITION AND MOLDED ARTICLE DECORATED WITH HOT-STAMPING FOIL

(71) Applicant: TOYOBO MC Corporation, Osaka (JP)

(72) Inventors: Kaori FURUKAWA, Shiga (JP); Takahiro SHIMIZU, Shiga (JP)

(73) Assignee: TOYOBO MC Corporation, Osaka (JP)

(21) Appl. No.: 18/281,882

(22) PCT Filed: Mar. 22, 2022
(86) PCT No.: PCT/JP2022/013258

§ 371 Date: Sep. 13, 2023

(30) Foreign Application Priority Data
Mar. 26, 2021 (JP) 2021-053916

(51) Int. Cl. C08L 67/02; B29C 45/00; B29K 67/00; B29K 105/00

(52) U.S. Cl. CPC C08L 67/02; B29C 45/0001; B29C 45/0005; B29C 45/0053; B29K 2067/003; B29K 2067/006; B29K 2105/0085; B29K 2995/0072; B29K 2995/0082; B29K 2995/0097; C08L 2205/025; C08L 2205/035; C08L 2205/06

(57) ABSTRACT

A polyester resin composition including: 30 to 55 parts by mass of a polybutylene terephthalate resin (A), 8 to 38 parts by mass of a polyethylene terephthalate resin (B), 3 to 20 parts by mass of a copolymerized polyester resin (C), 0 to 8 parts by mass of a polycarbonate-based resin (D), and 4 to 23 parts by mass of a carbon fiber-based reinforcement (E), and 0 to 2 parts by mass of an transesterification inhibitor (F) with respect to 100 parts by mass of a total amount of (A), (B), (C), (D), and (E), wherein (C) is a copolymerized polyethylene terephthalate resin (C1) and/or a copolymerized polybutylene terephthalate resin (C2). The polyester resin composition has a flexural modulus of 5.8 GPa or more, and a molded article formed of the polyester resin composition is highly rigid, has reduced defects, and may be decorated by hot-stamping.

### TECHNICAL FIELD

The present invention relates to a polyester resin composition comprising a thermoplastic polyester resin and carbon fibers and reinforced by the carbon fibers. Specifically, the present invention relates to a polyester resin composition from which a molded article being highly rigid and highly strong, having less appearance defects due to, for example, floating of fibers of the molded article, having a good mirror surface appearance, and being superior in surface smoothness can be obtained and which is suitable for surface decoration secondary processing, especially hot-stamping decoration.

### BACKGROUND ART

In general, in the case of performing hot-stamping (foil stamping) processing, surface smoothness of a molded article is required in order to acquire an improved appearance after the processing. Under such circumstances, resin compositions superior in surface secondary processability using a styrene-based resin or the like superior in molding processability have been proposed (Patent Documents 1, 2, and 3). However, these materials do not contain any fiber reinforcement, and therefore are insufficient in rigidity depending on the application of a molded article.

Patent Document 4 proposes a substrate for hot-stamping made of a polylactic acid resin composition containing a glass fiber reinforcement, but the base material is also insufficient in rigidity. Usually, an inorganic reinforcement such as glass fiber is added in order to obtain sufficient rigidity, but when the added amount is large, the inorganic reinforcement such as glass fiber is prone to float on a surface of a molded article and sufficient surface smoothness is not obtained, so that the molded article is not suitable for hot-stamping decoration. In that case, it is necessary to apply a primer in order to impart surface smoothness and foil adhesion, and there are problems of an increase in the number of processing steps and an increase in cost.

For this reason, in recent years, a resin composition for a molded article superior in surface smoothness and capable of being decorated by hot-stamping has been required in order to simplify the process and reduce the cost for parts required to have rigidity.

### PRIOR ART DOCUMENTS

### Patent Documents

Patent Document 1: JP-A-09-249780
Patent Document 2: JP-A-10-060221
Patent Document 3: JP-A-11-060856
Patent Document 4: JP-A-2015-120807

### SUMMARY OF THE INVENTION

### Problems to be Solved by the Invention

A challenge of the present invention is to provide a polyester resin composition a molded article of which is highly rigid, but has less appearance defects due to, for example, floating of a fiber reinforcement, has a good mirror surface appearance, is superior in surface smoothness, and is capable of being decorated by hot-stamping.

### Means for Solving the Problems

As a result of intensive studies on the configuration and properties of a polyester-based resin composition in order to solve the above challenge, the present inventors have found that the above challenge can be achieved by incorporating appropriate amounts of specific resins and appropriately adjusting the ratio of respective components, thereby accomplishing the present invention.

Specifically, the present invention includes the following configurations.
[1] A polyester resin composition comprising: 30 to 55 parts by mass of a polybutylene terephthalate resin (A), 8 to 38 parts by mass of a polyethylene terephthalate resin (B), 3 to 20 parts by mass of a copolymerized polyester resin (C), 0 to 8 parts by mass of a polycarbonate-based resin (D), and 4 to 23 parts by mass of a carbon fiber-based reinforcement (B), wherein a total amount of (A), (B), (C), (D), and (E) is 100 parts by mass, the copolymerized polyester resin (C) is a copolymerized polyethylene terephthalate resin (C1) and/or a copolymerized polybutylene terephthalate resin (C2), the polyester resin composition contains 0 to 2 parts by mass of an transesterification inhibitor (F) with respect to 100 parts by mass of the total amount of (A), (B), (C), (D), and (E), and the polyester resin composition has a flexural modulus of 5.8 GPa or more.
[2] The polyester resin composition according to [1], wherein a molded article having a size of 100 mm×100 mm×3 mm (thickness) obtained by injection molding the polyester resin composition at a cylinder temperature of 275° C. and a mold temperature of 105° C. has a surface roughness of 0.15 μm or less.
[3] The polyester resin composition according to [1] or [2], which is for a molded article to be decorated with a hot-stamping foil.
[4] A molded article formed of the polyester resin composition according to [1] or [2] and decorated with a hot-stamping foil.

### Effect of the Invention

According to the present invention, because the addition amount of a fiber reinforcement can be reduced owing to using, instead of glass fiber, carbon fiber, which is superior in rigidity in order to improve rigidity and because the floating of a fiber reinforcement on a surface can be inhibited owing to blending a resin low in crystallinity, the surface smoothness of a molded article can thereby be greatly improved, and the resulting molded article is suitable for hot-stamping decoration.

### MODE FOR CARRYING OUT THE INVENTION

Hereinafter, the present invention will be described in detail. The content of each component constituting the polyester resin composition described below is expressed in “part by mass”, and is parts by mass determined where the total amount of the polybutylene terephthalate resin (A), the polyethylene terephthalate resin (B), the copolymerized polyester resin (C), the polycarbonate-based resin (D), and the carbon fiber-based reinforcement (E) is adjusted to 100 parts by mass. In producing the polyester resin composition of the present invention, the mass ratio of the blending amount of each component is the content ratio in the polyester resin composition.

The polybutylene terephthalate resin (A) in the present invention is a resin as a main component in all the polyester resins in the resin composition of the present invention. It is preferable that the content thereof is the largest in all the polyester resins. The polybutylene terephthalate resin (A) is not particularly limited, but a homopolymer composed of terephthalic acid and 1,4-butanediol is preferably used. Where the amounts of all acid components and all glycol components constituting the polybutylene terephthalate resin (A) are 100 mol % and 100 mol %, respectively, other components may be copolymerized up to about 5 mol % as long as moldability, crystallinity, surface gloss, and the like are not impaired. That is, 5 mol % or less of other components may be copolymerized. Examples of such other components include components to be used for the copolymerized polybutylene terephthalate resin described below.

As a measure of the molecular weight of the polybutylene terephthalate resin (A), the reduced viscosity (0.1 g of the resin was dissolved in 25 ml of a mixed solvent of phenol/tetrachloroethane (mass ratio: 6/4), and the solution was measured at 30° C. using an Ubbelohde viscometer) is preferably in the range of 0.5 to 0.9 dl/g, and more preferably in the range of 0.6 to 0.8 dl/g. When the reduced viscosity is less than 0.5 dl/g, the toughness of the resin tends to be greatly reduced, and burrs are likely to occur due to excessively high fluidity. On the other hand, when the reduced viscosity is more than 0.9 di/g, it is difficult to obtain a sufficient appearance (the width of molding conditions is narrowed) with the resin composition of the present invention due to the effect of decreasing in fluidity.

The content of the polybutylene terephthalate resin (A) is 30 to 55 parts by mass, preferably 40 to 52 parts by mass, and more preferably 44 to 52 parts by mass. Blending the polybutylene terephthalate resin (A) within this range enables the resin composition to satisfy various properties.

The polyethylene terephthalate resin (B) in the present invention is basically a homopolymer of ethylene terephthalate units. Where the amounts of all acid components and all glycol components constituting the polyethylene terephthalate resin (B) are 100 mol % and 100 mol %, respectively, other components may be copolymerized up to about 5 mol % as long as various properties are not impaired. That is, 5 mol % or less of other components may be copolymerized. Examples of such other components include components to be used for the copolymerized polyethylene terephthalate resin described below. Such other components also include diethylene glycol produced through condensation of ethylene glycol during polymerization.

As a measure of the molecular weight of the polyethylene terephthalate resin (B), the reduced viscosity (0.1 g of the resin was dissolved in 25 ml of a mixed solvent of phenol/tetrachloroethane (mass ratio: 6/4), and the solution was measured at 30° C. using an Ubbelohde viscometer) is preferably 0.4 to 1.0 dl/g, and more preferably 0.5 to 0.9 dl/g. When the reduced viscosity is less than 0.4 di/g, the strength of the resin tends to decrease, and when the reduced viscosity is more than 1.0 dl/g, the fluidity of the resin tends to decrease.

The content of the polyethylene terephthalate resin (B) is 8 to 38 parts by mass, and preferably 10 to 35 parts by mass. Blending the polyethylene terephthalate resin (B) within this range enables the resin composition to satisfy various properties.

The copolymerized polyester resin (C) in the present invention is a copolymerized polyethylene terephthalate resin (C1) and/or a copolymerized polybutylene terephthalate resin (C2).

The copolymerized polyethylene terephthalate resin (C1) in the present invention is a resin in which ethylene glycol accounts for 40 mol % or more and the total amount of terephthalic acid and ethylene glycol accounts for 80 to 180 mol % where the amount of all constituent acid components is 100 mol % and the amount of all constituent glycol components is 100 mol %. The copolymerized polyethylene terephthalate resin (C1) is preferably a resin in which ethylene glycol accounts for 50 mol % or more and the total amount of terephthalic acid and ethylene glycol accounts for 150 to 175 mol %. The copolymerized polyethylene terephthalate resin (C1) may contain at least one selected from the group consisting of isophthalic acid, sebacic acid, adipic acid, trimellitic acid, 2,6-naphthalenedicarboxylic acid, diethylene glycol, neopentyl glycol, 1,4-cyclohexanedimethanol, 1,4-butanediol, 1,2-propanediol, 1,3-propanediol, and 2-methyl-1,3-propanediol as a copolymerization component, and is preferably amorphous. Among them, neopentyl glycol or a combination of neopentyl glycol and isophthalic acid is preferable as a copolymerization component from the viewpoint of various properties. As the copolymerization component, 1,4-butanediol preferably accounts for 20 mol % or less.

Where the amount of all glycol components constituting the copolymerized polyethylene terephthalate resin (C1) is 100 mol %, the copolymerization ratio of neopentyl glycol is preferably 20 to 60 mol %, and more preferably 25 to 50 mol %.

Where the amount of all acid components constituting the copolymerized polyethylene terephthalate resin (C1) is 100 mol %, the copolymerization ratio of isophthalic acid is preferably 20 to 60 mol %, and more preferably 25 to 50 mol %.

As a measure of the molecular weight of the copolymerized polyethylene terephthalate resin (C1), the reduced viscosity (0.1 g of the resin was dissolved in 25 ml of a mixed solvent of phenol/tetrachloroethane (mass ratio: 6/4), and the solution was measured at 30° C. using an Ubbelohde viscometer), which slightly varies depending on a specific copolymerization composition, is preferably 0.4 to 1.5 dl/g, and more preferably 0.4 to 1.3 dl/g. When the reduced viscosity is less than 0.4 dl/g, the toughness tends to decrease, and when the reduced viscosity is more than 1.5 dl/g, the fluidity tends to decrease.

The copolymerized polybutylene terephthalate resin (C2) in the present invention is a resin in which 1,4-butanediol accounts for 80 mol % or more and the total amount of terephthalic acid and 1,4-butanediol accounts for 120 to 180 mol % where the amount of all constituent acid components is 100 mol % and the amount of all constituent glycol components is 100 moil. The copolymerized polybutylene terephthalate resin (C2) is preferably a resin in which 1,4-butanediol accounts for 80 mol % or more and the total amount of terephthalic acid and 1,4-butanediol accounts for 140 to 180 mol %. The copolymerized polybutylene terephthalate resin (C2) may contain at least one selected from the group consisting of isophthalic acid, sebacic acid, adipic acid, trimellitic acid, 2,6-naphthalenedicarboxylic acid, ethylene glycol, diethylene glycol, neopentyl glycol, 1,4-cyclohexanedimethanol, 1,2-propanediol, 1,3-propanediol, and 2-methyl-1,3-propanediol as a copolymerization component. Among them, isophthalic acid is preferable as a copolymerization component, and where the amount of all acid component constituting the copolymerized polybutylene terephthalate resin (C2) is 100 mol %, the copolymerization ratio is preferably 20 to 80 moil, more preferably 20 to 60 mol %, and still more preferably 20 to 40 mol %. When the copolymerization ratio is less than 20 mol %, transferability to a mold is poor, and it tends to be difficult to obtain a sufficient appearance, and when the copolymerization amount is more than 80 mol %, a decrease in molding cycle and a decrease in releasability may be caused.

As a measure of the molecular weight of the copolymerized polybutylene terephthalate resin (C2), the reduced viscosity (0.1 g of the resin was dissolved in 25 ml of a mixed solvent of phenol/tetrachloroethane (mass ratio: 6/4), and the solution was measured at 30° C. using an Ubbelohde viscometer), which slightly varies depending on a specific copolymerization composition, is preferably 0.4 to 1.5 dl/g, and more preferably 0.4 to 1.3 dl/g. When the reduced viscosity is less than 0.4 dl/g, the toughness tends to decrease, and when the reduced viscosity is more than 1.5 dl/g, the fluidity tends to decrease.

The content of the copolymerized polyester resin (C) is 3 to 20 parts by mass, preferably 7 to 18 parts by mass, and more preferably 9 to 17 parts by mass. A content of less than 3 parts by mass leads to conspicuous appearance defects due to floating of the fiber reinforcement and mold transfer defects. Whereas a content of more than 20 parts by mass is undesirable because such a content leads to an elongated molding cycle though a favorable appearance of a molded article is obtained.

As the copolymerized polyester resin (C), the copolymerized polyethylene terephthalate resin (C1) or the copolymerized polybutylene terephthalate resin (C2) may be used alone, or the copolymerized polyethylene terephthalate resin (C1) and the copolymerized polybutylene terephthalate resin (C2) may be used in combination, but the use in combination is a more preferred embodiment. When the copolymerized polyethylene terephthalate resin (C1) and the copolymerized polybutylene terephthalate resin (C2) are used in combination, the mass ratio thereof (C1:C2) is preferably 80:20 to 30:70, more preferably 70:30 to 40:60, and still more preferably 60:40 to 50:50. The use of the copolymerized polyethylene terephthalate resin (C1) and the copolymerized polybutylene terephthalate resin (C2) in combination at the above mass ratio can make a molded article obtained from the polyester resin composition of the present invention have a good mirror surface appearance.

The polycarbonate in the polycarbonate-based resin (D) to be used in the present invention can be produced by a solvent method, namely, a reaction of a dihydric phenol with a carbonate precursor such as phosgene or a transesterification reaction of a dihydric phenol with a carbonate precursor such as diphenyl carbonate in the presence of a known acid receptor and a molecular weight modifier in a solvent such as methylene chloride. Herein, examples of a dihydric phenol preferably used include bisphenols, and particularly include 2,2-bis(4-hydroxyphenyl)propane, namely, bisphenol A. A material obtained by replacing a part or all of bisphenol A is replaced by another dihydric phenol is also available. Examples of the dihydric phenol other than bisphenol A include such compounds as hydroquinone, 4,4-dihydroxydiphenyl, and bis(4-hydroxyphenyl)alkanes, and halogenated bisphenols such as bis(3,5-dibromo-4-hydroxyphenyl)propane and bis(3,5-dichloro-4-hydroxyphenyl)propane. The polycarbonate may be either a homopolymer using one dihydric phenol or a copolymer using two or more dihydric phenols. As the polycarbonate-based resin (D), a resin composed only of polycarbonate is preferably used. The polycarbonate-based resin (D) may be a resin obtained by copolymerizing a component other than polycarbonate (for example, a polyester component) as long as the effect of the present invention is not impaired (20% by mass or less).

The polycarbonate-based resin (D) to be used in the present invention is particularly preferably one having high fluidity, and one having a melt volume rate (unit: cm³/10 min) of 20 to 100 as measured at 300° C. under a load of 1.2 kg is preferably used. The melt volume rate is more preferably 25 to 95, and still more preferably 30 to 90. The use of one having a melt volume rate of less than 20 will cause a significant decrease in fluidity, so that the strand stability may be deteriorated or the moldability may be deteriorated. When the melt volume rate is more than 100, physical properties are prone to deteriorate due to an excessively low molecular weight or problems such as gas generation due to decomposition are prone to occur.

The content of the polycarbonate-based resin (D) used in the present invention is 0 to 8 parts by mass. Since blending of a predetermined amount of the copolymerized polyester resin (C) can afford a polyester resin composition having the effect of the present invention, the polycarbonate-based resin (D) is not an essential component. However, blending of the polycarbonate-based resin (D) can make a molded article obtained from the polyester resin composition of the present invention have a better mirror surface appearance. When the polycarbonate-based resin (D) is blended, the blending amount thereof is preferably 2 to 6 parts by mass. A blending amount of more than 8 parts by mass is undesirable because such an amount is prone to lead to a deteriorated molding cycle due to a decrease in crystallinity, appearance defects due to a decrease in fluidity, and the like.

In the present invention, it is a more preferable embodiment to use the copolymerized polyethylene terephthalate resin (C1) and the copolymerized polybutylene terephthalate resin (C2) in combination as the copolymerized polyester resin (C) and further blend the polycarbonate-based resin (D). Blending the copolymerized polyethylene terephthalate resin (C1), the copolymerized polybutylene terephthalate resin (C2), and the polycarbonate-based resin (D) in a prescribed ratio makes it possible to highly control the floating of a fiber reinforcement, especially carbon fiber, and a molded article having a further superior mirror surface appearance can be formed.

The carbon fiber-based reinforcement (E) in the present invention is not particularly limited as long as it contains carbon fibers having a cut length of about 3 to 8 mm. The manufacturing method is also not limited as long as it is a generally disclosed method. Carbon fibers may be used which have a surface to which a coupling agent or a sizing agent is adhered for improving the wettability of the resin and improving the handleability. There are various coupling agents such as an amino type, an epoxy type, and a mercapto type, and an epoxy type is preferable. The sizing agent is preferably one of an epoxy type or a urethane type. The adhesion amount is preferably, but not particularly limited to, 0.1 to 5 parts by mass with respect to 100 parts by mass of carbon fiber.

The cut length of a carbon fiber can be measured by electron microscope observation.

In the polyester resin composition of the present invention, an inorganic reinforcement other than carbon fibers may be used in combination as the carbon fiber-based reinforcement (E) depending on the purpose and as long as the properties are not impaired. Specifically, mica, wollastonite, needle-like wollastonite, glass flakes, glass beads, and the like, which are generally commercially available, can be used, and those treated with a generally known coupling agent can also be used without any problems. In the case where an inorganic reinforcement other than carbon fibers is used in combination, in studying the content of each of the components of the polyester resin composition of the present invention, the total amount of the carbon fibers and the inorganic reinforcement other than the carbon fibers is defined as the content of the carbon fiber-based reinforcement (E). When carbon fibers and other inorganic reinforcements are used in combination, it is preferable to use 50% by mass or more of carbon fibers in the carbon fiber-based reinforcement (E). The use of only carbon fibers as the carbon fiber-based reinforcement (E) without use in combination of other inorganic reinforcements is also a preferable embodiment.

The content of the carbon fiber-based reinforcement (E) in the present invention is 4 to 23 parts by mass, preferably 5 to 22 parts by mass, and more preferably 7 to 13 parts by mass from the viewpoint of rigidity, strength, and appearance.

As the name suggests, the transesterification inhibitor (F) to be used in the present invention is a stabilizer that prevents a transesterification reaction of a polyester-based resin. In an alloy or the like of polyester-based resins, no matter how much the conditions at the time of production are optimized, transesterification has occurred not a little due to addition of a heat history. When the degree of the occurrence of the transesterification becomes very high, characteristics expected due to the alloy are not obtained less and less. In particular, since transesterification of polybutylene terephthalate and polycarbonate often occurs, this case is undesirable because the crystallinity of polybutylene terephthalate is greatly reduced. In the present invention, the transesterification reaction between the polybutylene terephthalate resin (A) and the polycarbonate-based resin (D) is particularly prevented by adding the transesterification inhibitor (F), whereby appropriate crystallinity can be maintained.

As the transesterification inhibitor (F), a phosphorus-based compound having an effect of catalyst deactivation of a polyester-based resin can be preferably used, and for example, “ADK STAB AX-71” manufactured by ADEKA Corporation can be used.

The addition amount of the transesterification inhibitor (F) to be used in the present invention is 0 to 2 parts by mass, and when the polycarbonate-based resin (D) is not added, it is not necessary to add the transesterification inhibitor (F). When the transesterification inhibitor (F) is added, the addition amount thereof is preferably 0.05 to 2 parts by mass, more preferably 0.1 to 1 parts by mass, and still more preferably 0.1 to 0.5 parts by mass. When the addition amount is less than 0.05 parts by mass, the required transesterification prevention performance is often not exhibited, and conversely, even when the addition amount is more than 2 parts by mass, not only the effect of the addition is not significantly exhibited, but also a gas or the like may be increased.

In addition, the polyester resin composition of the present invention may, as necessary, contain various known additives as long as the properties as the present invention are not impaired. Examples of the known additives include coloring agents such as pigments, release agents, heat stabilizers, antioxidants, ultraviolet absorbers, light stabilizers, plasticizers, modifiers, anti-static agents, flame retardants, and dyes. These additives may be blended up to 5% by mass in total where the polyester resin composition is 100% by mass. That is, the total amount of (A), (B), (C), (D), (E), and (F) is preferably 95 to 100% by mass in 100% by mass of the polyester resin composition.

Examples of the release agent include long-chain fatty acids or esters and metal salts thereof, amide-based compounds, polyethylene wax, silicone, and polyethylene oxide. The long-chain fatty acid particularly preferably has 12 or more carbon atoms, and examples thereof include stearic acid, 12-hydroxystearic acid, behenic acid, and montanic acid, and part or all carboxylic acid may be esterified with monoglycol or polyglycol, or may form a metal salt. Examples of the amide-based compound include ethylene bisterephthalamide and methylene bisstearylamide. These release agents may be used singly or as a mixture.

As a method for producing the polyester resin composition of the present invention, the polyester resin composition can be produced by mixing the above-described components and, if necessary, various additives, and melt-kneading the mixture. As the melt-kneading method, any method known to those skilled in the art can be used, and a single screw extruder, a twin-screw extruder, a pressure kneader, a Banbury mixer, or the like can be used. Among them, it is preferable to use a twin-screw extruder. As general melt-kneading conditions, in a twin-screw extruder, the cylinder temperature is 240 to 290° C., and the kneading time is 2 to 15 minutes.

Since the polyester resin composition of the present invention has the configuration described above, the flexural modulus thereof measured according to ISO-178 is 5.8 GPa or more. The flexural modulus is preferably 7 GPa or more, and more preferably 8 GPa or more. The upper limit of the flexural modulus is not particularly limited, but is about 20 GPa with the polyester resin composition of the present invention. Measurement of the flexural modulus is as described in Examples described later.

A molded article having a size of 100 mm×100 mm×3 mm (thickness) obtained by injection molding the polyester resin composition at a cylinder temperature of 275° C. and a mold temperature of 105° C. preferably has a surface roughness of 0.15 μm or less. This surface roughness can be achieved when the polyester resin composition has the configuration described above. The surface roughness is determined by a measurement method described in Examples described later.

The hot-stamping in the present invention is not particularly limited as long as the polyester resin composition of the present invention is used. For example, the hot stamp can be prepared by molding the polyester resin composition of the present invention into a molded article by a known molding method such as injection molding, laminating a hot-stamping foil (transfer foil) onto the molded article, and transferring the foil by hot pressing. In this way, a molded article decorated with the hot-stamping foil can be obtained.

The configuration of the hot-stamping foil includes a metal foil layer and an adhesive layer as essential components, and is preferably composed of the following five layers: 1) a base film layer, 2) a release layer, 3) a protective layer, 4) a metal foil layer, and 5) an adhesive layer. The constituent components of each layer are not particularly limited, and the thermal transfer method is also not particularly limited.

### EXAMPLES

In the following, the present invention will be described in more specifically by way of Examples, but the present invention is not limited to the Examples. The measured values described in Examples were measured by the following methods.

(1) Reduced Viscosity of Polyester Resin

0.1 g of a resin was dissolved in 25 ml of a mixed solvent of phenol/tetrachloroethane (mass ratio: 6/4), and the reduced viscosity was measured at 30° C. using an Ubbelohde viscosity tube. (unit: dl/g)

(2) Specular Appearance of Molded Article

A molded article having a size of 100 mm×100 mm×3 mm was obtained by injection molding at a cylinder temperature of 275° C. and a mold temperature of 105° C. The molding was performed in an injection speed range where the filling time was 1 second. The appearance of the molded article obtained was visually observed and judged according to the following criteria. “0” and “0” are of no particular problems.

⊙: There are no appearance defects due to floating of the reinforcement on a surface, and the image produced by reflection on a molded article is clearly seen.
o: There are slight appearance defects occurred in a part (in particular, an end part or the like of a molded article), or an image reflected on the molded article looks slightly distorted.

x: There are appearance defects on the entire molded article, or an image reflected on the molded article is unclear.

(3) Surface Roughness

A molded article having a size of 100 mm×100 mm×3 mm (thickness) was obtained by injection molding at a cylinder temperature of 275° C. and a mold temperature of 105° C. The molding was performed in an injection speed range where the filling time was 1 second. The central part of a surface having a size of 100 mm×100 mm in the molded article obtained was observed at a magnification of 10 times using a white interference microscope (trade name: “VertScan VS1530, manufactured by Hitachi High-Tech Science Corporation”), and the surface roughness (arithmetic mean height (Sa)) was measured. When the surface roughness was 0.15 μm or less, it was determined as acceptable “0”, and when the surface roughness was more than 0.15 μm, it was determined as fail “x”.

(4) Flexural Modulus

Measurement was performed in accordance with ISO-178. The test piece was obtained by injection molding at a cylinder temperature of 275° C., a mold temperature of 100° C., a filling time of 1 second or less, and a cooling time of 12 seconds.

The blend components used in Examples and Comparative Examples are shown below.
Polybutylene terephthalate resin (A): manufactured by Toyobo Co., Ltd., reduced viscosity: 0.75 dl/g
Polyethylene terephthalate resin (B): manufactured by Toyobo Co., Ltd., reduced viscosity: 0.63 di/g
Copolymerized polyethylene terephthalate resin (C1): copolymer having a composition ratio of TPA//EG/NPG=100//70/30 (mol %), manufactured by Toyobo Co., Ltd., prototype of TOYOBO VYLON (registered trademark), reduced viscosity: 0.83 dl/g
Copolymerized polybutylene terephthalate resin (C2): copolymer having a composition ratio of TPA/IPA//1,4-BD=70/30//100 (mol %), manufactured by Toyobo Co., Ltd., prototype of TOYOBO VYLON (registered trademark), reduced viscosity: 0.73 dl/g (The abbreviations denote TPA: terephthalic acid, IPA: isophthalic acid, 1,4-BD: 1,4-butanediol, EG: ethylene glycol, and NPG: neopentyl glycol component, respectively.)
Polycarbonate-based resin (D): manufactured by Sumika Styron Polycarbonate Limited, “SD POLYCA 200-80”, melt volume rate (300° C., load 1.2 kg): 80 cm³/10 min
Carbon fiber-based reinforcement (E): “CFUW” manufactured by Nippon Polymer Sangyo Co., Ltd., chopped strand of carbon fiber bundle having cut length of 6 mm
Transesterification inhibitor (F): “ADK STAB AX-71” manufactured by ADEKA Corporation
Glass fiber-based reinforcement: “T-120H” manufactured by Nippon Electric Glass Co., Ltd.

### Examples 1 to 8, Comparative Examples 1 to 6

For the polyester resin compositions of Examples and Comparative Examples, the raw materials were weighed according to the blending ratios (parts by mass) shown in Tables 1 and 2, and melt-kneaded with a 35 φ twin-screw extruder (manufactured by Toshiba Machine Co., Ltd.) at a cylinder temperature of 270° C. and a screw rotation speed of 200 rpm. Raw materials other than the reinforcement were fed into the twin-screw extruder through a hopper, and the reinforcement was fed into the twin-screw extruder through a vent port by side feed. The resulting pellets of the polyester resin compositions were dried, and then samples for various evaluations were molded with an injection molding machine. The evaluation results are shown in Tables 1 and 2.

TABLE 1

| | | Unit | Example 1 | Example 2 | Example 3 | Example 4 | Example 5 | Example 6 | Example 7 | Example 8 |
|---|---|---|---|---|---|---|---|---|---|---|
| Composition | Polybutylene terephthalate | parts | 50 | 47 | 48 | 47 | 46 | 48 | 48 | 50 |
| | resin (A) | by mass | | | | | | | | |
| | Polyethylene terephthalate | parts | 33 | 31 | 22 | 21 | 11.5 | 32.5 | 33 | 33 |
| | resin (B) | by mass | | | | | | | | |
| | Copolymerized polyethylene | parts | 5 | 5 | 7.5 | 5 | 10 | | 8 | 5 |
| | terephthalate resin (C1) | by mass | | | | | | | | |
| | Copolymerized polybutylene | parts | 4 | 4 | 5.5 | 4 | 7 | 8.5 | | 4 |
| | terephthalate resin (C2) | by mass | | | | | | | | |
| | Polycarbonate-based resin (D) | parts | 3 | 3 | 4.5 | 3 | 5.5 | 3 | 3 | |
| | | by mass | | | | | | | | |
| | Carbon fiber-based | parts | 5 | 10 | 12.5 | 20 | 20 | 8 | 8 | 8 |
| | reinforcement (E) | by mass | | | | | | | | |
| | Transesterification inhibitor | parts | 0.2 | 0.2 | 0.2 | 0.2 | 0.2 | 0.2 | 0.2 | |
| | (F) | by mass | | | | | | | | |
| Properties | Flexural modulus | GPa | 6.0 | 9.5 | 11.5 | 17.0 | 15.8 | 8.5 | 8.5 | 8.4 |
| | Specular appearance of | — | ⊙ | ⊙ | ⊙ | ◯ | ◯ | ◯ | ◯ | ◯ |
| | molded article | | | | | | | | | |
| | Surface roughness | — | ◯ | ◯ | ◯ | ◯ | ◯ | ◯ | ◯ | ◯ |
| | | μm | 0.08 | 0.11 | 0.11 | 0.14 | 0.14 | 0.12 | 0.10 | 0.10 |

TABLE 2

| | | | Comparative | Comparative | Comparative | Comparative | Comparative | Comparative |
|---|---|---|---|---|---|---|---|---|
| | | Unit | Example 1 | Example 2 | Example 3 | Example 4 | Example 5 | Example 6 |
| Composition | Polybutylene terephthalate resin (A) | parts | 51 | 43 | 44 | 35 | 44 | 50 |
| | | by mass | | | | | | |
| | Polyethylene terephthalate resin (B) | parts | 34 | 27 | 29 | 23 | 19 | 32 |
| | | by mass | | | | | | |
| | Copolymerized polyethylene | parts | | | 5 | 5 | 5 | |
| | terephthalate resin (C1) | by mass | | | | | | |
| | Copolymerized polybutylene | parts | | | 4 | 4 | 4 | |
| | terephthalate resin (C2) | by mass | | | | | | |
| | Polycarbonate-based resin (D) | parts | | | 3 | 3 | 3 | 8 |
| | | by mass | | | | | | |
| | Carbon fiber-based reinforcement (E) | parts | | | | | 25 | 10 |
| | | by mass | | | | | | |
| | Transesterification inhibitor (F) | parts | | | 0.2 | 0.2 | 0.2 | 0.2 |
| | | by mass | | | | | | |
| | Glass fiber-based reinforcement | parts | 15 | 30 | 15 | 30 | | |
| | | by mass | | | | | | |
| Properties | Flexural modulus | GPa | 5.4 | 10.0 | 5.2 | 9.1 | 20.0 | 8.6 |
| | Specular appearance of molded article | — | X | X | ◯ | X | X | X |
| | (visual) | | | | | | | |
| | Surface roughness | — | X | X | ◯ | X | X | ◯ |
| | | μm | 0.16 | 0.19 | 0.13 | 0.17 | 0.16 | 0.13 |

As is apparent from Tables 1 and 2, it is found that Examples 1 to 8 are superior in mirror surface appearance and surface smoothness (surface roughness: 0.15 μm or less) while maintaining a flexural modulus of 5.8 GPa or more because they followed the prescribed formulation.

On the other hand, Comparative Examples 1 and 2 were inferior in rigidity (flexural modulus) or inferior in mirror surface appearance and surface smoothness to Examples because the copolymerized polyester resin (C) and the polycarbonate-based resin (D) were not blended and a glass fiber reinforcement was blended instead of the carbon fiber-based reinforcement (E). Comparative Examples 3 and 4 were inferior in rigidity (flexural modulus) or inferior in mirror surface appearance and surface smoothness to Examples because a glass fiber reinforcement was blended instead of the carbon fiber-based reinforcement (E). Comparative Example 5 was superior in rigidity, but boor in mirror surface appearance and surface smoothness because the blending amount of the carbon fiber-based reinforcement (E) was larger than the specified amount. Comparative Example 6 is inferior in mirror surface appearance to Examples because the polycarbonate-based resin (D) was blended, but the copolymerized polyester resin (C) was not blended.

### INDUSTRIAL APPLICABILITY

According to the present invention, it is possible to obtain a molded article which is highly rigid, but has less appearance defects due to, for example, floating of a fiber reinforcement of the molded article, has a good mirror surface appearance, and is superior in surface smoothness. Thus, the present invention can be suitably used for parts requiring secondary surface processing, such as hot-stamping, and requiring a certain degree of rigidity among interior parts and decorative parts for automobiles, various emblems, design covers, and parts of home appliance housings which are obtained by injection molding. Therefore, the present invention greatly contributes to the industry.

1. A polyester resin composition comprising: 30 to 55 parts by mass of a polybutylene terephthalate resin (A), 8 to 38 parts by mass of a polyethylene terephthalate resin (B), 3 to 20 parts by mass of a copolymerized polyester resin (C), 0 to 8 parts by mass of a polycarbonate-based resin (D), and 4 to 23 parts by mass of a carbon fiber-based reinforcement (E),
wherein a total amount of (A), (B), (C), (D), and (E) is 100 parts by mass, the copolymerized polyester resin (C) is a copolymerized polyethylene terephthalate resin (C1) and/or a copolymerized polybutylene terephthalate resin (C2), the polyester resin composition contains 0 to 2 parts by mass of an transesterification inhibitor (F) with respect to 100 parts by mass of the total amount of (A), (B), (C), (D), and (E), and the polyester resin composition has a flexural modulus of 5.8 GPa or more.

2. The polyester resin composition according to claim 1, wherein a molded article having a size of 100 mm×100 mm×3 mm (thickness) obtained by injection molding the polyester resin composition at a cylinder temperature of 275° C. and a mold temperature of 105° C. has a surface roughness of 0.15 μm or less.

3. The polyester resin composition according to claim 1, which is for a molded article to be decorated with a hot-stamping foil.

4. A molded article formed of the polyester resin composition according to claim 1 and decorated with a hot-stamping foil.
